(19) United States
(12) Patent Application Publication
(10) Pub. No.: US 2019/0093951 A1
(43) Pub. Date: Mar. 28, 2019

(54) AUTOMATED MEASUREMENT PROCESS OF THE TEMPERATURE OF A FUSION FURNACE BY MEANS OF A TEMPERATURE PROBE

(71) Applicant: EUROPEA MICROFUSIONI AEROSPAZIALI S.P.A., Morra de Sanctis (IT)

(72) Inventors: Pasquale CORRERA, Morra de Sanctis (IT); Pasquale GALLUCCI, Morra de Sanctis (IT); Gerardo MARIANI, Morra de Sanctis (IT); Lorelai IFTODE, Morra de Sanctis (IT)

(21) Appl. No.: 16/094,152

(22) PCT Filed: May 31, 2017
(86) PCT No.: PCT/IT2017/000109

§ 371 Date: Oct. 16, 2018

(30) Foreign Application Priority Data
Jun. 3, 2016 (IT) 102016000057262

(51) Int. Cl. F27B 14/20; G01K 1/14; G01K 7/02; G01K 1/02; G01K 7/13; H05B 6/06; H05B 6/24; F27B 14/06

(52) U.S. Cl. CPC F27B 14/20; G01K 1/146; G01K 7/02; G01K 1/02; F27D 2019/0003; H05B 6/067; H05B 6/24; F27B 14/061; G01K 7/13

(57) ABSTRACT

The present invention relates to a process for measuring the temperature of a fusion furnace, in particular for the production of superalloy components with directional (DS)/monocrystalline (SX) grain structure by means of a lost wax precision casting process by means of a temperature probe, said fusion furnace comprising a melting chamber, a thermal chamber in connection with said melting chamber, and an extraction chamber in connection with said thermal chamber, a valve interposed between said two melting and thermal chambers, said probe comprising a thermocouple for high temperatures, a support element for positioning the temperature probe in the melting chamber of the furnace, displacement and measurement means of the position of the thermocouple for displacing and measuring the position of the thermocouple within the thermal chamber of the furnace, control device to actuate and control said displacement and measuring means.

The present invention relates to a temperature probe for the automated measurement of the temperature of a fusion furnace. Further, the present invention relates to a temperature measurement and control process of the temperature of a fusion furnace by means of the temperature probe according to the invention.

More generally, the system developed for automated measurement of temperature can generally be used for the thermal field survey within any fusion furnace (of the resistive or inductive type), e.g. used for the production of superalloy components having directional (DS)/monocrystalline (SX) grain structure by the lost wax precision casting process.

More specifically, the present invention relates to a temperature probe to be used in high vacuum furnaces for production, by means of the lost wax precision casting process (investment casting) of superalloy components with a DS/SX grain structure for aerospace, naval and industrial turbines.

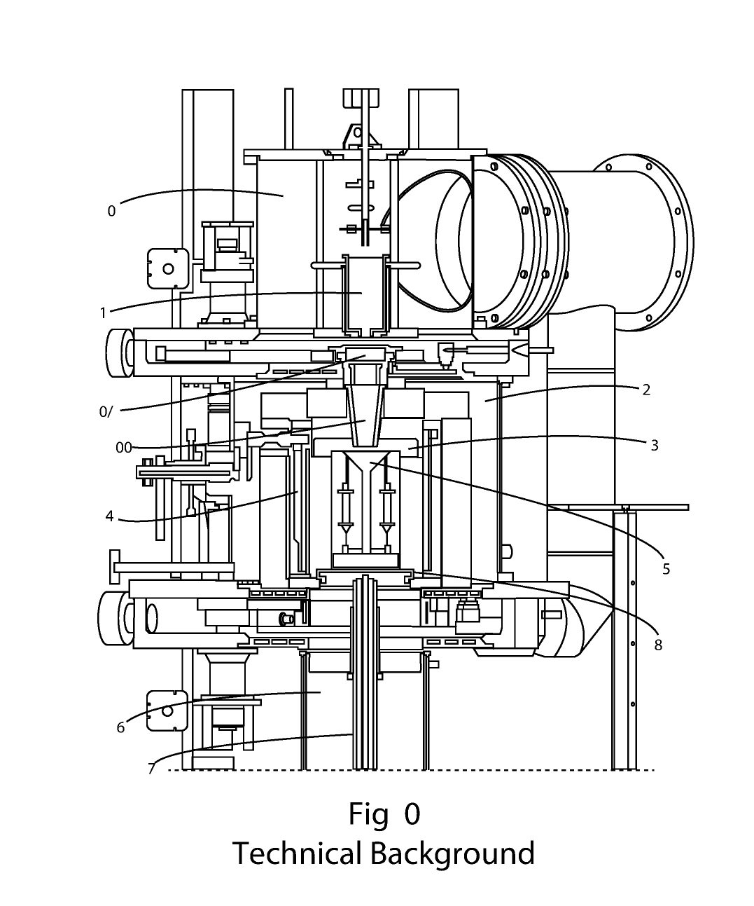

At the state of the art, as shown in FIG. 1, a furnace for the production of superalloy components with directional (DS)/monocrystalline (SX) grain structure by the lost wax precision casting process comprises a melting chamber 1, within which the superalloy fusion is carried out, contained within a dedicated ceramic die 2 by induction heating; a thermal chamber 3, or hot chamber, positioned below the melting chamber 1 to which it is connected through a valve 10, mainly provided with a pouring tube 11 and a graphite hollow cylinder 4 (or a hot graphite chamber), which, externally heated by a graphite resistance 5, or internally, by induction, to the passage of an electric current, acts as an active element for radiation heating of the ceramic shell 6, in which the superalloy is poured; an extraction chamber 7, or cold chamber, provided with an electric piston 8 for moving the ceramic shell 6 positioned on a copper chill plate 9 (cooled by a flow of water) housed on the piston head 8.

The production process (or cast process) of components with DS/SX grain structure is mainly based on the setting of a high in modulus (of 10¹ to 10²° C./cm, with specific values for each category of components), and clearly set in direction (unidirectional, along the gravitational axis, coinciding with the principal axis of the component), spatial thermal gradient during the superalloy solidification phase by means of:
the generation and maintenance of a given thermal field within the graphite thermal chamber 4 and of a set cooling of the chill plate 9 (cooling water temperature within the range 20°-24° C.), and
the use of a specific withdrawal profile of the shell 6 from the thermal chamber 3 to the extraction chamber 7, according to a controlled piston 8 descent program (withdrawal rate within the range 10⁻¹ to 10¹ mm/min).

If the furnace is not provided with control thermocouples inside the hot chamber, a periodic inspection of the thermal field must be carried out to monitor the stability of the cast process and correct the temperature where necessary.

The thermal field verification procedure involves measuring the temperature along the main axis of the furnace during the simulation of a cast at a predetermined depth in the thermal chamber 3 with respect to the probe datum fixed on the valve 10 positioned between the thermal chamber 3 and the melting chamber 1. The measurements are made by means of manual insertion, within the thermal chamber 3 (in the absence of the ceramic shell 6 to keep free the axial zone of the furnace) through the melting chamber 1 and the pouring tube 2 of a type “B” thermocouple probe temperature, more generally for high temperatures. Said operation of temperature probe insertion must be carried out in a relatively short time and in such a way as to accurately position the thermocouple at set depths within the thermal chamber, for a precise evaluation of the thermal field.

Getting a balancing between short time and accuracy of temperature measurement is difficult to achieve by manual operation.

It is an object of the present invention that of carrying out the measurement and control process of the temperature inside the thermal chamber of a fusion furnace for the production of components in superalloy with DS/SX grain by the lost wax precision casting process in a short time and getting accurate measurements.

It is specific object of the present invention a measurement process of the thermal field of a fusion furnace, in particular for the production of superalloy components with directional (DS)/monocrystalline (SX) grain structure by a lost wax precision casting process, by means of a system for the control and the measurement of the temperature inside of a fusion furnace, said fusion furnace comprising a melting chamber, a thermal chamber in connection with said melting chamber, and an extraction chamber in connection with said thermal chamber, a valve interposed between said two melting and thermal chambers, said system comprising a temperature probe for the measurement of the thermal field in said fusion furnace, said temperature probe comprising a thermocouple for high temperatures, a support element for the positioning of the temperature probe in the melting chamber of the furnace, displacement and measurement means of the position of the thermocouple for the displacement and the measurement of the position of the thermocouple inside of the thermal chamber of the furnace, a control device apt to activate and control said displacement and measurement means for the execution of control programs of said probe, said process providing the following sequential steps:
insertion of the probe in the melting chamber of the furnace;
activation of the probe by means of said control device selecting an execution program;
execution of the selected program by means of displacement of the thermocouple to the depth inside of the thermal chamber of the furnace indicated in the operating procedure of the specific program with:
measurement of the temperature,
recording the value of the temperature only when, for 2 mins, the temperature variations do not exceed ±1° C. the measured temperature value, and the correspondent value of the measurement position with respect to a zero position or probe datum;
comparison of the measured temperature with the limit values set by the selected program,

wherein the program to execute or the selected program provides the following steps:
a) insertion of the thermocouple in correspondence of the interface zone between the thermal chamber and the extraction chamber of the furnace, and measurement of the temperature and comparison of the measured value with the value provided at such depth,
if as a result of step a) the measured temperature does not correspond with the value provided at said depth, it is provided the following step:
b) displacement of the thermocouple to a preset depth at approximately the center of the thermal chamber of the furnace and measurement of the temperature,
if as a result of step b) the temperature at said preset depth has a not acceptable value, it is provided the following:
c) sending to the user interface of the control device the communication “Cast Anomaly”;
d) adjustment of the controller of the furnace.

Preferably, according to the invention, the drive phase of the probe by means of said control device can provide
activation of the control push-button,
selection of the number of the furnace subject to surveying,
insertion of the nominal temperature of the furnace, or cast temperature to survey and,
selection of an execution program;
opening of the valve between the melting chamber and the thermal chamber of the furnace.

Still according to the invention, said control device can comprise a programmable logic controller or PLC, a driver, a touch-screen interface for the control and the monitoring of the procedure by an operator, and control push-buttons, said PLC can be connected by connection means, preferably in Ethernet/IP net, with the control system of the furnace, so as to be able to communicate the displacement positions of the probe and the information related to the control programs in execution, and after the phase of insertion of the probe, is provided the phase of:
connection of the probe with the furnace by connection means.

Always according to the invention, said zero position or probe datum can correspond to the lower limit of the valve in correspondence of the thermal chamber.

Furthermore according to the invention, the data acquired from said PLC and sent to said control system of the furnace can be stored in the database of the company Manufactory Execution System (MES), and the measured temperature and the correspondent position of the thermocouple are archived in the database of the company MES.

Further, according to the invention, a program to execute can be the program for the switch on of the furnace that provides after step d) the following step:
e) return to step a), for a maximum of three times;
if as a result of the phase b) the temperature at said preset depth corresponds substantially to the preferred one the furnace is turned off and a communication to the maintenance service of the furnace is sent;
if as a result of step a) the measured temperature does not correspond with the value provided at said depth,
and if the temperature at said preset depth has not been verified, it is provided step b),
if as a result of step b) the temperature measured at said preset depth corresponds substantially to the preferred one, then the procedure is completed with success,
if as a result of step b) the temperature measured at said preset depth corresponds substantially to the temperature of attention it is provided step d),
if as a result of step b) the temperature measured at said preset depth is not acceptable, step c) and d) are provided.

Alternatively, according to the invention, the selected program or program to be executed can be the control and adjustment program of the temperature of the furnace that provides after step d) the following steps:
f) extraction of the thermocouple from the thermal chamber of the furnace;
g) closing of valve for a sufficient time, preferably 15′, for the stabilization of the temperature in the furnace and then step b) is provided;
if as a result of step b) the temperature at said preset depth is not the preferred one, it is returned to step d) and the following, for a maximum of 3 times;
if as a result of step b) the temperature at said preset depth corresponds to the preferred one, it is returned to step a);
if as a result of step a) the measured temperature does not correspond with the value provided at such depth, the furnace is turned off and a communication to the maintenance service of the furnace is sent;
if as a result of step a) the measured temperature corresponds with the value provided at said depth the process is completed with success.

Furthermore, according to the invention, the selected program can be the turn-off program of the furnace that provides the following steps:
h) displacement of the thermocouple to a preset depth at approximately the center of the thermal chamber of the furnace and recording the temperature,
i) displacement of the thermocouple in correspondence of the interface zone between the thermal chamber and the extraction chamber of the furnace and measurement and recording of the temperature;
j) turning off the furnace.

Always according to the invention, said interface zone between the thermal chamber and the extraction chamber of the furnace can be equivalent to a depth approximately of 23″ inside of the thermal chamber with respect to said zero position or probe datum.

In particular, according to the invention, said preset depth can correspond to approximately 14″ inside of the thermal chamber of the furnace with respect to said zero position or probe datum.

Finally according to the invention, the preferred temperature at said preset depth can be comprised between +3° C. and −3° C. with respect to the nominal temperature of the furnace, the temperature of attention at said preset depth can be comprised between +3° C. and +20° C. or −3° C. and −20° C. with respect to the nominal temperature of the furnace, and the temperature not accepted at said preset depth is higher than +20° C. and lower than −20° C. with respect to the nominal temperature of the furnace.

Further it is an object of the present invention, a system for the control and the measurement of the temperature inside of a fusion furnace, in particular for the production of superalloy components with directional (DS)/monocrystalline (SX) grain structure by a lost wax precision casting process, said fusion furnace comprising a melting chamber, a thermal chamber in connection with said melting chamber, and an extraction chamber in connection with said thermal chamber, a valve interposed between said two melting and thermal chambers, said system comprising a temperature probe for the measurement of the thermal field in said fusion furnace, said temperature probe comprising a thermocouple for high temperatures, a support element for the positioning of the temperature probe in the melting chamber of the furnace, displacement and measurement means of the position of the thermocouple for the displacement and the measurement of the position of the thermocouple inside the thermal chamber of the furnace, a control device apt to activate and control said displacement and measurement means for the execution of control programs of said probe and a control device of said probe for the execution of the control programs of said probe by means of the process described in the above.

Preferably according to the invention, said support element of said probe can be a flange.

Still according to the invention, said thermocouple can be of “B” type.

Always according to the invention, said thermocouple can be housed inside a tube, preferably made of alumina.

Furthermore according to the invention, said displacement and measurement means of the position of the probe can comprise a motor with high precision encoder apt to measure the position of the thermocouple inside the thermal chamber of the furnace.

Further according to the invention, said displacement and measurement means of the position of the probe can comprise means for the transmission of the rotational motion with reduction of the number of turns, in particular an angular reducer.

Preferably according to the invention, said displacement and measurement means of the position of the probe can comprise means for the translation of said thermocouple, in particular a linear belt guide.

Finally according to the invention, said probe can comprise a graded bar, arranged in correspondence of the thermocouple, and said thermocouple can provide a pointer, preferably an arrow, in order to visually assess, by means of the sliding of said pointer with respect to said graded bar, of the correct displacement of said thermocouple inside of the furnace.

The invention will be now described in an illustrative but not limitative way, with particular reference to the drawings of the enclosed figures, wherein:

FIG. 1 shows a front perspective view of a furnace for the production of superalloy components with directional (DS)/monocrystalline (SX) grain structure by means of the known lost wax precision casting process;

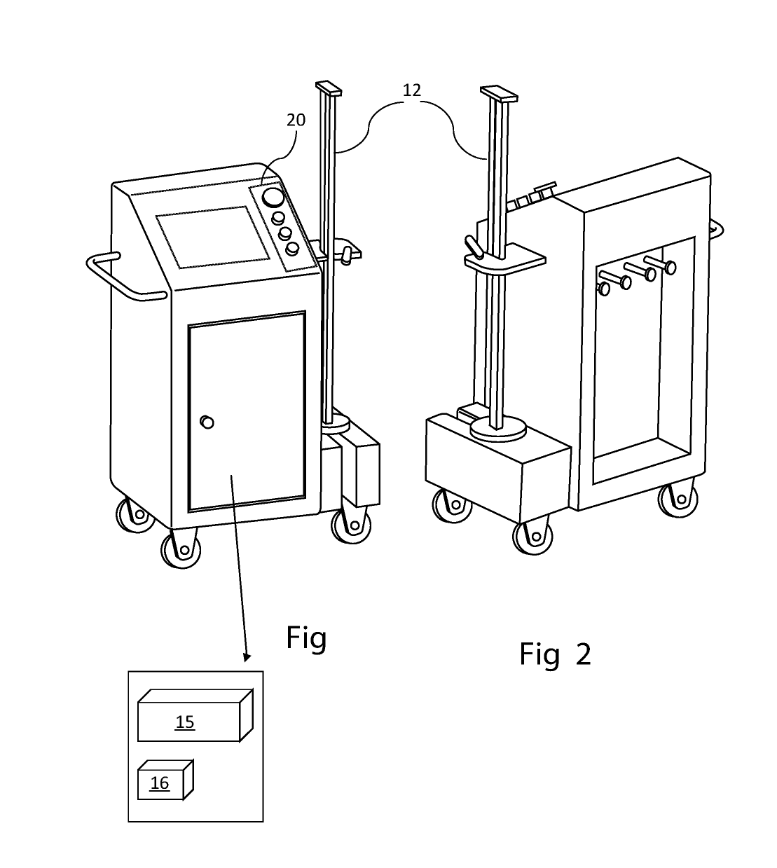

FIG. 2 shows a front perspective view of the probe according to the invention housed in a control device;

FIG. 3 shows a rear perspective view of FIG. 2;

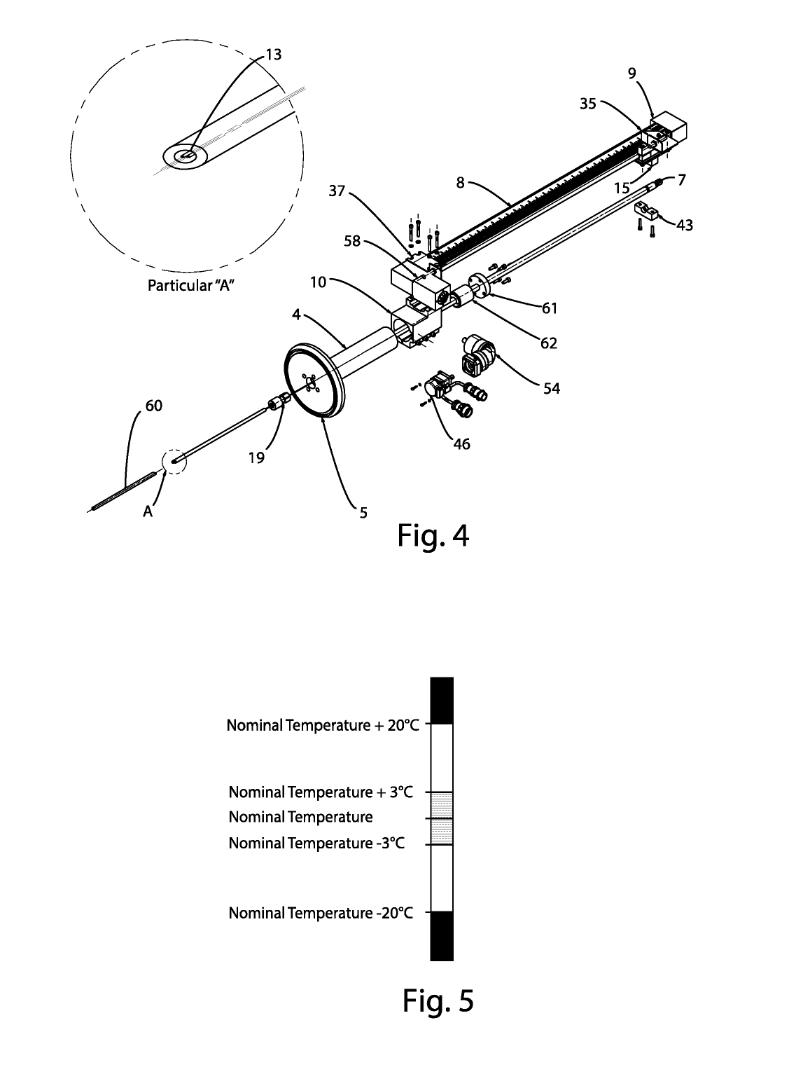

FIG. 4 shows an exploded perspective view of the probe according to the invention;

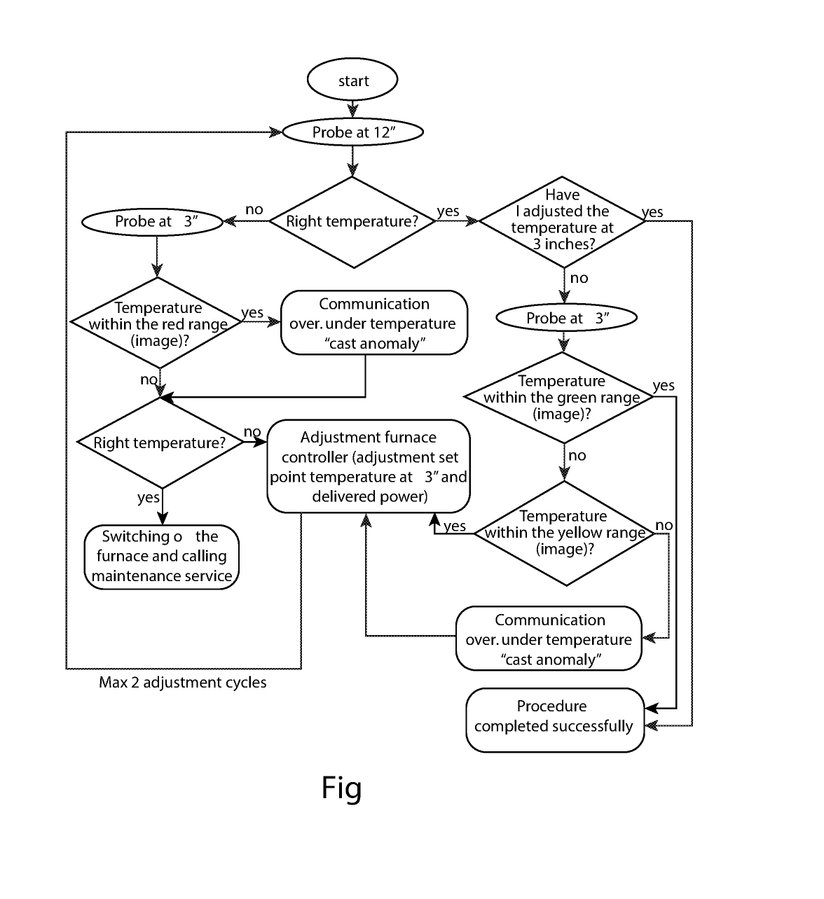

FIG. 5 shows a scheme of preferred temperature levels in the thermal chamber at a depth of 14″;

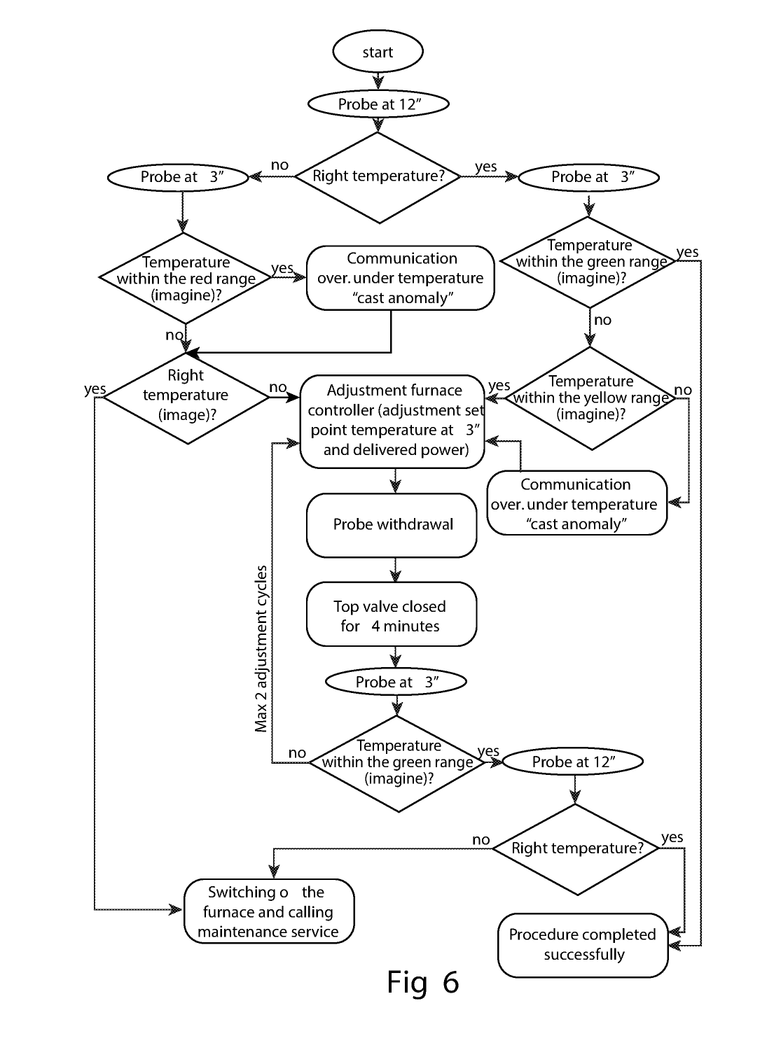

FIG. 6 shows a flow diagram of the control program for switch on the furnace by means of the probe according to the invention;

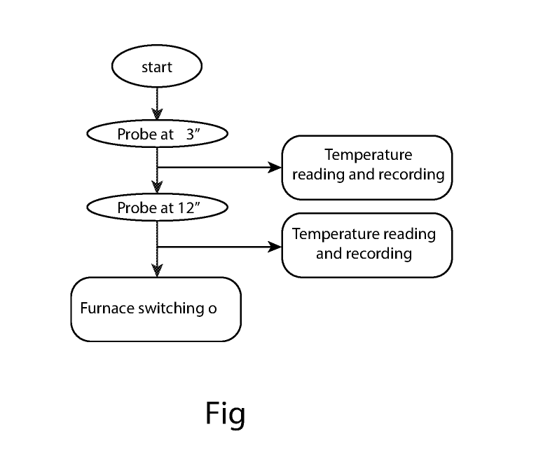

FIG. 7 shows a flow diagram of the program for controlling and adjusting the furnace temperature by means of the probe according to the invention; and

FIG. 8 shows a flow diagram of the program for switching off the furnace by means of the probe according to the invention.

Making reference to FIGS. 2 to 4, it is shown the temperature probe according to the invention indicated by the numerical reference 12.

The temperature probe 12 according to the invention mainly comprises a thermocouple 13 for high temperatures, in particular of “B” type, preferably housed within a tube 60, preferably comprised of alumina, a support element 5 of the probe 12, particularly a flange 5, for positioning the temperature probe 12 in the melting chamber 1, means for actuating and handling the thermocouple 13, in particular a motor with high precision encoder 46, an angular reducer 54 capable of transmitting rotational motion with a reduction in the number of revolutions and minimizing the dimensions, and a linear belt guide 9 for the displacement of the thermocouple 13. The control device of the temperature probe 12 comprises a programmable logic controller (or PLC) 15, a driver 16, a touch-screen interface 19 for controlling and monitoring the procedure by an operator, and control buttons 20.

The movement of the thermocouple 13 is motorized, the positioning depth inside the thermal chamber 3 is accurately measured by means of the high precision encoder 46. In addition, the probe 12 may include a graded bar 8, positioned aside the thermocouple 13, ensuring the possibility to even visually assess, by sliding an arrow indicator 35 connected to the thermocouple 13, the correct displacement within the furnace, as foreseen in the set measurement program.

The temperature measurement procedure by thermocouple 13 is managed automatically by means of the control and monitoring system managed by a dedicated software or program.

The touch-screen interface 19 allows the operator to control the whole procedure.

The automatic probe 12 is fully integrated with the furnace automation platform: PLC 15 of the probe 12 is connected to the Eterneth/IP network with the furnace control architecture so that it can communicate the motor displacement positions and the information provided of the carried out procedure. Other means of connection, such as any one-to-one communication or link bus, may be eventually provided. Real-time data acquired are stored in the company's Manufactory Execution System (MES) database. By company MES it is meant a centralized IT system with management and control role of the company production, providing, among other functions, also the direct connection to machineries for dispatching production programs and corresponding recording of the machine process parameters for monitoring and traceability of the production itself.

The control program and its thermal probe operator interface for automatic control of the verification procedure of the thermal field within furnace thermal chamber 3 provides a number of programs for carrying out various control procedures including those necessary for switch on/off of the furnace and for periodic control and adjustment during the production, of the furnace temperature.

The process according to the invention for the measurement of the thermal field of a fusion furnace, particularly for the production of superalloy components with directional (DS)/monocrystalline (SX) grain structure by means of the lost wax precision casting process by the automated probe 12 according to the invention basically provides the following steps, on the basis of the set control program:
insertion of the automated probe 12 into the melting chamber 1;
connection of the automated probe 12 with the furnace through an ethernet cable or other connecting means;
activation of the push button 20 through a guided procedure;
selection of the furnace number to be subjected to the survey,
insertion of the nominal furnace temperature, or cast temperature, to be investigated and,
on the basis of the needing, selection of one of the “Furnace Switch-On”, “Furnace Switch-Off” and “Furnace Temperature Control and Adjustment” programs;
opening of the valve 10 between the melting chamber 1 and the thermal chamber 3 of the furnace;
start of the procedure with the displacement of the thermocouple 13 at different depths inside the thermal chamber 3 indicated in the operation mode of the specific program carried out (Furnace Switch-On, Furnace Temperature Control and Adjustment, Furnace Switch-Off) with:
temperature measurement,
temperature recording: on the basis of a specific algorithm, the software decides when the measured temperature is stable, recording the value only when, for 2 min, the temperature variations do not exceed ±1° C.; the measured temperature value and the corresponding value of the measuring position (depth within the thermal chamber) with respect to the zero position (probe datum) corresponding to the lower limit of the valve 10 are stored in the company's MES database;
comparison of the recorded temperature with the limit values imposed by the specific control program;
decision on how to continue the furnace temperature measurement and control process, by adjustment actions, if necessary (based on the comparison of the measured temperature with the expected temperature), of the set-point temperature at 14″ and thus of the power supplied to heat the graphite resistance to correct the temperature to the expected values as summarized in the following flow diagrams corresponding to each program as shown in FIGS. 6-8.

Specifically, the program for switching on the furnace, as shown in FIG. 6, provides:
a) insertion of the thermocouple 13 at a depth of 23″ inside the thermal chamber 3 of the furnace (the 23″ position corresponds to the interface zone between the thermal chamber 4 and the extraction chamber 7) and temperature measurement and comparison of the measured value TM with the TX value expected or provided at this depth, in particular the expected TX value must not exceed a maximum limit, depending on the temperature of the furnace (casting temperature), i.e. the T14 temperature at a depth of 14″ (the 14″ position inside the thermal chamber 3 corresponds to a predetermined depth at about the center of the thermal chamber 3). In FIG. 5, preferred temperature ranges at 14″ are shown in green, between +3° C. and −3° C. with respect to the nominal furnace temperature, in yellow the attention temperature range at 14″, between +3° C. and +20° C. or between −3° C. and −20° C. compared to the nominal furnace temperature, and in red the not accepted temperature range at 14″, higher than +20° C. and lower than −20° C. with respect to the nominal furnace temperature;
if, after step a), the measured temperature TM does not correspond to the TX value expected at this depth, it is proceeded with the step:
b) displacement of the thermocouple 13 to the position 14″ inside the thermal chamber 3 of the furnace and measurement of the temperature,
if, after step b), the temperature T14″ in position 14″ is in the red band, it is proceeded as follows:
c) sending the “Anomaly Cast” communication to the user interface 19 for additional/in-depth checks on some of the quality characteristics of the components cast under said abnormal furnace temperature conditions;
d) setting the furnace controller (set-point of the cast temperature and therefore of the power delivered) and
e) return to step a), up to 3 adjustment cycles of this type can be made;
if after step b) the temperature T14″ in the position 14″ is in the green range, the furnace is switched off and a communication is sent to the furnace maintenance service;
if, after step a), the measured temperature TM corresponds to the TX value expected at this depth,
and if the temperature has not been checked at a depth of 14″, it is proceeded with step b)
if after step b) the temperature measured at 14″ is within the green range, then the procedure is successfully completed,
if after step b) the temperature measured at 14″is in the yellow range, it is proceeded to step d),
if, after step b), the temperature measured at 14″is within the red range, it is proceeded to steps c) and d).

During the production process, the program for controlling and regulating the furnace temperature shown in FIG. 7 is executed, including the same steps as described for the furnace switch-on program, but step
e) is replaced by the following steps:
f) extraction of the thermocouple 13 from the thermal chamber 3 of the furnace;
g) closure of valve 10 for a sufficient time, preferably 15′, for the stabilization of temperature within the furnace and then passage to step b);
if, after step b), the temperature T14″ in position 14″ is not in the green range, it returns to step d) and following ones, with a maximum of 3 adjustment cycles;
if after step b) the temperature T14″ in position 14″ is in the green range, it returns to step a);
if, after step a), the measured temperature TM does not correspond to the TX value expected at this depth, the furnace is switched off and a communication is sent to the furnace maintenance service;

If, after step a), the measured temperature TM corresponds to the TX value for this depth, the procedure is successfully completed.

Finally, the furnace's shutdown program, shown in FIG. 8, is used before the furnace switching off to verify the temperature at which the components were made after the last check, i.e. the latest control and adjustment program before switching off the furnace.

The furnace shutdown program according to the invention comprises the following steps:
h) displacing the thermocouple 13 to a depth of 14″ within the thermal chamber 3 of the furnace and measuring and recording the temperature;
i) displacing the thermocouple 13 at a depth of 23″ inside the furnace's thermal chamber 3 and measuring and recording the temperature;
j) switching off the furnace.

In the foregoing, preferred embodiments of the present invention have been described and variants have been suggested, but it is to be understood that those skilled in the art will be able to introduce modifications and changes without departing for the scope as defined by the claims enclosed.

1. Measurement process of the thermal field of a fusion furnace, in particular for the production of superalloy components with DS/SX grain structure though lost wax precision casting, by means of a system for the control and the measurement of the temperature inside of a fusion furnace, said fusion furnace comprising a melting chamber, a thermal chamber in connection with said melting chamber, and an extraction chamber in connection with said thermal chamber, a valve interposed between said two melting and thermal chambers, said system comprising a temperature probe for the measurement of the thermal field in said fusion furnace, a support element for the positioning of the temperature probe in the melting chamber of the furnace, displacement and measurement means of the position of the thermocouple for the displacement and the measurement of the position of the thermocouple inside of the thermal chamber of the furnace, a control device apt to activate and control said displacement and measurement means for the execution of control programs of said probe, said process providing the following sequential steps:
insertion of the probe in the melting chamber of the furnace;
activation of the probe by means of said control device selecting an execution program;
execution of the selected program by means of displacement of the thermocouple to the depth inside of the thermal chamber of the furnace indicated in the operating procedure of the specific program with:
measurement of the temperature,
recording the value of the temperature (TM) only when, for 2 mins, the temperature variations do not exceed ±1° C. the measured temperature value and the correspondent value of the measured position with respect to a zero position or probe datum;
comparison of the measured temperature (TM) with the limit values set by, the selected program,
wherein the program to execute or the selected program provides the following steps:
a) insertion of the thermocouple in correspondence of the interface zone between the thermal chamber and the extraction chamber of the furnace, and measurement of the temperature and comparison of the measured value (TM) with the value (TX) provided at such depth,
if as a result of step a) the measured temperature (TM) does not correspond with the value (TX) provided at said depth, it is provided the following step:
b) displacement of the thermocouple to a preset depth at approximately the center of the thermal chamber of the furnace and measurement of the temperature,
if as a result of step b) the temperature (T14″) at said preset depth has not an acceptable value, it is provided the following:
c) sending to the user interface of the control device the communication “Cast Anomaly”;
d) adjustment of the controller of the furnace.

2. Process according to claim 1, characterized in that the drive phase of the probe by means of said control device provides
activation of the control push-button,
selection of the number of the furnace subject to surveying,
insertion of the nominal temperature of the furnace, or cast temperature to survey and,
selection of an execution program;
opening of the valve between the melting chamber and the thermal chamber of the furnace.

3. Process according to claim 1, characterized in that said control device comprises a programmable logic controller or PLC, a driver, a touch-screen interface for the control and the monitoring of the procedure by an operator, and control push-buttons, in that said PLC is connected by connection means, preferably in Ethernet/IP net, with the control system of the furnace, so as to be able to communicate the displacement positions of the probe and the information related to the control programs in execution, and in that after the phase of insertion of the probe, is provided the phase of:
connection of the probe with the furnace by connection means,

4. Process according to claim 1, characterized in that said zero position or probe datum corresponds to the lower limit of the valve in correspondence of the thermal chamber.

5. Process according to claim 3, characterized in that the data acquired from said PLC and sent to said control system of the furnace are stored in the database of the company Manufactory Execution System (MES), and in that the measured temperature (TM) and the correspondent position of the thermocouple are archived in the database of the company MES.

6. Process according to claim 1, characterized in that a program to execute is the program for the start of the furnace that provides after step d) the following step:
e) return to step a), for a maximum of three times;
if as a result of the phase b) the temperature (T14″) at said preset depth corresponds substantially to the preferred one the furnace is turned off and a communication to the maintenance service of the furnace is sent;
if as a result of step a) the measured temperature (TM) does not correspond with the value (TX) provided at said depth,
and if the temperature at said preset depth has not been verified, it is provided step b),
if as a result of step b) the temperature measured at said preset depth corresponds substantially to the preferred one, then the procedure is completed with success,
if as a result of step b) the temperature measured at said preset depth corresponds substantially to the temperature of attention it is provided step d),
if as a result of step b) the temperature measured at said preset depth is not acceptable, step c) and d) are provided.

7. Process according to claim 1, wherein the selected program or program to be executed is the control and adjustment program of the temperature of the furnace that provides after step d) the following steps:
f) extraction, of the thermocouple from the thermal chamber of the furnace;
g) closing of valve for a sufficient time, preferably 15′, for the stabilization of the temperature in the furnace and after step b) is provided;
if as a result of step b) the temperature (T14″) at said preset depth is not the preferred one, it is returned to step d) and the following, for a maximum of 3 times;
if as a result of step b) the temperature (T14″) at said preset depth corresponds to the preferred one, it is returned step a);
if as a result of step a) the measured temperature (TM) does not correspond with the value (TX) provided at such depth, the furnace is turned off and a communication to the maintenance service of the furnace is sent;
if as a result of step a) the measured temperature (TM) corresponds with the value (TX) provided at said depth the process is completed with success.

8. Process according to claim 7, wherein the selected program, after the program according to claim 7, is the turn-off program of the furnace that provides the following steps:
h) displacement of the thermocouple to a preset depth at approximately the center of the thermal chamber of the furnace and recording the temperature,
i) displacement of the thermocouple in correspondence of the interface zone between the thermal chamber and the extraction chamber of the furnace and measurement and recording of the temperature;
j) turning off the furnace.

9. Process according to claim 5, characterized in that the interface zone between the thermal chamber and the extraction chamber of the furnace is equivalent to a depth approximately of 23″ inside of the thermal chamber with respect to said zero position or probe datum.

10. Process according to claim 5, characterized in that the preset depth corresponds to approximately 14″ inside of the thermal chamber of the furnace with respect to said zero position or probe datum.

11. Process according to claim 5, characterized in that the preferred temperature at said preset depth is comprised between +3° C. and −3° C. with respect to the nominal temperature of the furnace, the temperature of attention at said preset depth is comprised between +3° C. and +20° C. or −3° C. and −20° C. with respect to the nominal temperature of the furnace, and the temperature accepted at said intermediate depth is higher than +20° C. and lower than −20° C. with respect to the nominal temperature of the furnace.

12. System for the control and the measurement of the temperature inside of a fusion furnace, in particular for the production of superalloy components with a DS/SX grain structure through lost wax precision casting, said fusion furnace comprising a melting chamber, a thermal chamber in connection with said melting chamber, and an extraction chamber in connection with said thermal chamber, a valve interposed between said two melting and thermal chambers, said system comprising a temperature probe for the measurement of the thermal field in said fusion furnace, a support element for the positioning of the temperature probe in the melting chamber of the furnace, displacement and measurement means of the position of the thermocouple for the displacement and the measurement of the position of the thermocouple inside of the thermal chamber of the furnace, a control device apt to activate and control said displacement and measurement means for the execution of control programs of said probe by means of the process according to claim 1.

13. System according to claim 12, characterized in that said support element of said probe is a flange.

14. System according to claim 13, characterized in that said thermocouple is of “B” type.

15. System according to claim 13, characterized in that said thermocouple is housed inside a tube, preferably made of alumina.

16. System according to claim 13, characterized in that said displacement and measurement means of the position of the probe comprise a motor with high precision encoder apt to measure the position of the thermocouple inside the thermal chamber of the furnace.

17. System according to claim 13, characterized in that said displacement and measurement means of the position of the probe comprise means for the transmission of the rotation motion with reduction of the number of turns, in particular an angular reducer.

18. System according to claim 13, characterized in that said displacement and measurement means of the position of the probe comprise means for the translation of said thermocouple, in particular a linear belt guide.

19. System according to claim 13, characterized in that said probe comprises a graded bar, arranged in correspondence of the thermocouple, and in that said thermocouple provides a pointer, preferably an arrow, in order to visually assess, by means of the sliding of said pointer with respect to said graduated bar, of the correct displacement of said thermocouple inside of the furnace.
